(19) United States
(12) Patent Application Publication
(10) Pub. No.: US 2022/0371270 A1
(43) Pub. Date: Nov. 24, 2022

(54) MANUFACTURING APPARATUS FOR ADDITIVE MANUFACTURING OF THREE-DIMENSIONAL COMPONENTS

(71) Applicant: AMCM GmbH, Starnberg (DE)

(72) Inventor: Stefan Schoenmoser, Starnberg (DE)

(73) Assignee: AMCM GmbH, Starnberg (DE)

(21) Appl. No.: 17/774,649

(22) PCT Filed: Nov. 3, 2020
(86) PCT No.: PCT/EP2020/080750

§ 371 Date: May 5, 2022

(30) Foreign Application Priority Data
Nov. 28, 2019 (DE) 102019132253.7

(51) Int. Cl. B29C 64/232; B33Y 10/00; B33Y 30/00; B29C 64/153; B33Y 40/00; B29C 64/35

(52) U.S. Cl. CPC B29C 64/232; B33Y 10/00; B33Y 30/00; B29C 64/153; B33Y 40/00; B29C 64/35; B33Y 70/00

(57) ABSTRACT

Disclosed is a manufacturing device for additive manufacturing of three-dimensional elements by layer-by-layer application by at least one coating unit and locally selective solidification of a build-up material by at least one irradiation unit, the manufacturing device including a building shaft and a carrier with a building platform, wherein the element can be built up on the building platform within the building shaft, wherein the building shaft can be changed relatively in height with respect to the building platform and is sealable with respect to the latter during the layer-by-layer application in that during the layer-by-layer application between an inner surface of the building shaft and the carrier a gap is formed such that a part of the build-up material can at least partially penetrate to thereby seal the building shaft with respect to the carrier.

The invention relates to a manufacturing device for the additive manufacturing of three-dimensional elements by layer-by-layer application and locally selective solidification of a build-up material. The invention further relates to a manufacturing method for the additive manufacturing of three-dimensional elements and a system comprising a corresponding manufacturing device.

Manufacturing devices and corresponding methods for the additive manufacturing of three-dimensional elements by layer-by-layer application and locally selective solidification of a build-up material are known in principle from the prior art. For layer-by-layer application, at least one corresponding coating unit is usually provided. For local selective consolidation, at least one corresponding irradiation unit (e.g. comprising at least one laser) is usually provided.

Furthermore, it is known to build up the three-dimensional element on a building platform supported by a carrier (building platform carrier). Specifically, the element can be built up within a building shaft.

DE 10 2007 014 968 A1 describes a device for manufacturing objects by building them up layer-by-layer from powdery material. In one embodiment described there, outer walls of a building cylinder are extended downwards so that they allow the building space to be sealed off from the outside, even if inner walls are raised to such an extent that a gap is formed between them and the carrier. Excess material powder can thus be guided downwards through the gap and along the extended outer walls into the collection container. The gap thus only emerges after the manufacturing process has been completed and serves to drain off excess material. During the manufacturing process, the inner walls are probably sealed against a carrier (which DE 10 2007 014 968 A1 does not discuss further). In the prior art, corresponding seals are known in this context.

For example, US 2018/0345411 A1 describes such a seal. Specifically, this describes a device for the layer-by-layer manufacture of a product, wherein the device comprises a so-called tube which is movable (vertically) relative to a platform. Specifically, the tube remains in its position and the platform is (actively) moved within the tube between a start position and a lower end position.

In order to prevent (or at least make more difficult) build-up material from penetrating between tube and platform, a seal made of rubber or felt is provided in US 2018/0345411 A1, which is attached to an edge of the platform and extends in the circumferential direction. However, such seals are found to be disadvantageous. In particular, it has been recognised that jamming of the building platform may occur. Especially at high temperatures, damage to the seals may also occur (up to a melting of the same).

U.S. Pat. No. 10,413,968 B2 does without such a seal. In U.S. Pat. No. 10,413,968 B2 powder can penetrate between a so-called sleeve and a building plate. The surface roughness of the two elements is adjusted in such a way that it is still possible for the two elements to slide against each other. Powder that trickles through is then collected with the help of a bellows structure. However, the deliberate omission of a corresponding sealing is also regarded as disadvantageous, since then (despite the bellows structure for collecting in U.S. Pat. No. 10,413,968 B2) possibly faults or an increased cleaning effort have to be expected.

It is the object of the invention to provide a solution which is as simple as possible and yet effective in order to seal a building shaft of a manufacturing device for the additive manufacturing of three-dimensional elements with respect to a building platform, in particular also at high temperatures.

This object is solved in particular by a manufacturing device according to claim 1.

In particular, the object is solved by a manufacturing device for the additive manufacturing of three-dimensional elements by layer-by-layer application by means of at least one coating unit (as an element of the manufacturing device) and locally selective solidification of a build-up material by means of at least one irradiation unit (as an element of the manufacturing device), comprising a building shaft and a carrier as well as a building platform, wherein the element can be built up on the building platform within the building shaft, wherein the building shaft can be changed relatively in height with respect to the building platform (by means of a height adjustment device) (for example by lowering the building platform) and is sealable with respect to the building platform and/or the carrier during the layer-by-layer application in that during the layer-by-layer application between an inner surface of the building shaft and the carrier a gap is formed, preferably such that a portion of the build-up material can at least partially penetrate to thereby seal the building shaft with respect to the building platform and/or the carrier.

A key idea of the invention lies therein to form a gap between an inner surface of the building shaft and a carrier such that indeed a portion of the build-up material can penetrate into this gap, but is prevented from further penetration due to the configuration and arrangement of the gap. By that seals made of rubber or felt material can be dispensed with. In particular, a comparatively simple and yet reliable seal (in particular also at high temperatures) is achieved. It is therefore basically made possible that a portion of the build-up material can penetrate into the gap, but without continuously trickling through (after the part of the build-up material necessary for sealing or blocking has penetrated). In particular, there should be no permanent trickling through, as will be the case, for example, in the solution according to U.S. Pat. No. 10,413,968 B2.

Insofar as a “gap” is mentioned below or in the claims, this is intended to mean in particular the gap between the inner surface of the building shaft and the carrier and the building platform respectively (“and/or”), if nothing deviating is expressed.

The gap is preferably annular in horizontal section and extends vertically. A vertical extension is preferably (at least temporarily during the manufacturing process or layer-by-layer solidification of the build-up material) higher than wide (in relation to a horizontal section), preferably at least 5 times as high, further preferably at least 10 times as high as wide.

The gap preferably has an (over the vertical extension) at least substantially constant width. If the width varies, a minimum width preferably deviates no more than 50%, further preferably no more than 30%, still further preferably no more than 10% of a maximum width from the maximum width.

In particular, (unsolidified or not melted) build-up material can run into the gap by its gravity and thus provide a sealing function, so that in particular no further (unsolidified) build-up material can flow after or run in after. The gap in connection with the build-up material preferably forms a self-inhibiting seal. If necessary, in addition to gravity, an (over)pressure of a gas (process gas) present above the gap can at least partially cause flow in of material into the gap. Preferably, however, such an overpressure is prevented (in particular by that at both ends of the build-up material located in the gap and, if applicable, below the gap the same pressure is present).

The (unsolidified) build-up material can fill up an area that may possibly (due to the vertical relative movement of the building shaft) become free (in which the building shaft or a (lower) section of it was still located before the respective relative movement) as soon as the building shaft is moved relative to the building platform (e.g. by lowering the building platform). If this does not occur due to a self-inhibition of the build-up material occur (immediately) after a respective movement process of the building cylinder, in particular by a layer thickness, then correspondingly more build-up material can trickle in during a later movement process. Such a case can, if necessary, be taken into account in the amount of build-up material to be applied in a next step and/or an edge area of the building platform can remain free of the object to be built up (i.e. not be used), so that a non-uniform application in this area is unproblematic.

The manufacturing device according to the invention is particularly advantageous for processing pulverulent build-up material at (solidification) temperatures of 300° C. or more, in particular of 500° C. or more. At least with conventional sealing systems, at such high temperatures a destruction of the seal can happen or expensive sealing materials are required. Alternatively, a use at lower temperatures, possibly even below 0° C., is also conceivable.

All in all, a jamming of the building platform or the carrier in relation to the building shaft can be avoided in a simple manner.

The building shaft can be changed, in particular in relation to the building platform, relatively in its height. This can preferably be achieved by lowering the building platform relative to the building shaft. Alternatively or additionally, the building shaft can be raised (relative to a fixed point of the manufacturing device, such as a stand or support device in contact with the ground during use) in order to change the height (vertical positioning). In relation to a fixed point of the manufacturing device, either the building platform can be lowered or the building shaft can be raised or both. However, an exclusive lowering of the building platform is particularly preferred.

The building platform can be structurally separated from the carrier or form an integral (possibly monolithic) part of the carrier. In such a case, in particular an upper surface of the carrier shall be considered as building platform.

The carrier may at least in sections, in particular over at least 50% of its vertical extent, optionally over its entire vertical extent be as wide as or wider than the building platform.

The carrier is preferably dimensionally stable or does not change its shape during of the manufacturing processes. In particular, the carrier does not comprise a bellows structure and/or a collapsible structure.

In particular, only those sections should be assigned to the carrier that also have a load-bearing (or supporting) function (so that, for example, foldable structures are not to be assigned to the carrier, at least if they do not also have a supporting function at the same time).

A projection of the building platform onto a horizontal plane may lie entirely within a projection of the carrier onto the horizontal plane.

Particularly preferably is, for sealing purposes, at least in one state, optionally in several or all states, a section, in particular a pocket, is formed below the gap and/or below a lower end of the building shaft during the layer-by-layer application, which section, in particular with progressing layer-by-layer application, successively increases in size and fills with build-up material. The section (the pocket) is preferably (directly) connected to the lower end of the gap, so that build-up material can flow out of the gap into the section (the pocket). The section (the pocket) can be rectangular in cross-section and/or annular in three dimensions.

The gap is preferably, in at least one state (possibly also in an initial state during the manufacturing of the three-dimensional object), at least partially, open downwards (not tight or not sealed), in particular connected at its lower end to the above section (pocket).

Preferably, in at least one state (optionally in an initial state and/or in at least one intermediate state), a (cavity-) connection (in particular by means of the above section or the above pocket) is formed between a lower end of the gap and a volume region (preferably between an inner wall of a carrier shaft and an outer wall of the building shaft) which lies above the level of the lower end, for example lies at least 10%, preferably at least 50% of a vertical extension of the gap above a level of the lower end and/or lies at least 1 cm, preferably at least 10 cm above a level of a lower end of the gap.

Specifically, a structure may be formed which comprises the gap between the inner surface of the building shaft and the carrier as well as a further volume (in particular optionally a further gap, preferably between an inner wall of a carrier shaft and an outer wall of the building shaft) which is connected to the gap between the inner surface of the building shaft and the carrier (such that a fictitious particle, in particular a particle of the build-up material, may pass between the gap between inner surface of the building shaft and carrier and the further volume/gap). The further volume or the further gap can preferably only be reached by a fictitious particle in that the gap between inner surface of the building shaft and carrier is passed through to its lower end.

Specifically, a seal, in particular self-inhibition, with respect to inflowing build-up material can be achieved in that build-up material fills the gap up to a lower end and possibly (depending on the relative height of the building shaft) also fills a space below the gap. If necessary, the build-up material can also partially advance further upwards (e.g. vertically upwards) (starting from the lower end), in particular so that due to frictional forces and possibly a weight force of the ascended portion further flow is prevented.

In sections, a volume can be formed (including the gap between inner surface of the building shaft and carrier) which is U-shaped or V-shaped in cross-section (especially in a vertical section).

A vertical extension of the gap between inner surface of the building shaft and carrier can change during the manufacturing process, in particular it can shorten. Insofar as above and below dimensions of the gap and sections connected therewith (in particular the further volume already introduced above or the further gap mentioned above) are concerned, this preferably applies at least to one state (in particular to an initial state and/or a state in which the respective gap has a maximum length) during the manufacturing process, further preferably to all states between the maximum length of the gap and its average length (=average value between maximum and minimum length or, according to the embodiment, half maximum length).

The gap between inner surface of the building shaft and carrier extends, at least in one state during the manufacturing process, preferably over at least 20%, further preferably at least 50%, possibly at least 8% of a vertical extension of the building shaft (calculated from a lower end thereof to preferably an upper end at which material is fed in layers by means of the coating unit and/or to an upper flange).

The gap can be formed hollow-cylindrical (in particular with a circular or polygonal, especially quadrangular, preferably rectangular, possibly square, cross-section) and/or form an annular space which can surround the carrier.

At least in a (horizontal) cross-section, the gap can form an in particular closed (for example circular or polygonal, in particular rectangular or square and/or adapted to an outer geometry of the carrier) ring.

Preferably, the gap is formed by a (in particular hollow cylindrical) volume into which the building shaft can also penetrate (or from which the building shaft can be removed during manufacture, in particular successively, for example by lowering the platform). Insofar as a cylinder is referred to here and in the following, a cylinder is preferably meant which can have a circular cross-section, but does not have to have one (for example, polygonal, in particular quadrangular, possibly square, cross-sections are also possible).

In particular, the gap is formed when the first layer is applied by means of the coating unit.

The (in particular downwardly open) gap can, if necessary, successively shorten (with each further application step).

According to an embodiment, the gap can be formed by sliding into each other of building shaft and an element (element) comprising the carrier.

Preferably, the gap can be filled in that a coater (or the coating unit) applies build-up material and this flows into the gap. Possibly, before solidification of the first layer several passes of the coater may be necessary to fill the gap.

The coating unit is preferably configured such that it passes over the gap during coating.

Preferably, the building shaft can be sealed against the building platform or the carrier by means of self-sealing (or self-inhibition of the penetrating build-up material). In this way, a sealing can be achieved in a particularly simple manner.

For sealing, the gap can be or is filled with the material over at least 20%, preferably at least 50%, further preferably at least 80%, possibly (at least substantially) 100% of its vertical extension. This is to be seen in particular in contrast to the fact that (for example in U.S. Pat. No. 10,413,968 B2) although build-up material can penetrate into the gap, it passes through it continuously and to that extent cannot fill it up (not even over a certain section of its vertical extension).

By sealing it is to be understood in particular that the build-up material (in at least one state during the manufacturing process, preferably an initial state in which the first layer is applied) cannot pass (or only to a small extent) through the corresponding sealing structure, in particular cannot both penetrate into the gap (comparatively far, in particular into areas below the pocket) and run off downwards (into areas that distinctly lie, e.g. by at least 10 cm or at least 30 cm, below a level of a lower end of the gap in an initial state during manufacture). Preferably, the gap is at least partially filled during the application of the first layer, wherein the building shaft (in this state) extends to a maximum depth into an (in particular the above) element (element) comprising the carrier.

The carrier may comprise a carrier shaft, or such a shaft may be associated with the carrier, within which the building shaft may be arranged in a vertically changeable manner. The carrier shaft may have an inner surface and an outer surface and a shaft bottom. During the manufacturing process (in at least one state), a space between the building shaft (or the lower end thereof) and the shaft bottom of the carrier shaft may be filled and, if necessary, a space between the building shaft (or an outer surface thereof) and an inner surface of the carrier shaft.

If the building shaft is moved vertically (relatively seen) or changed with regard to its vertical relative position with respect to the carrier, build-up material may run into the carrier shaft, preferably by means of gravity.

In embodiments, at least one structure may be arranged on the carrier and/or the building shaft, which improves the flowing of the build-up material in the gap and/or at least one device may be arranged, which supports a better distribution by means of movement, in particular vibration and/or rotation. The manufacturing device may have or contain the build-up material (for example in a corresponding reservoir). The gap then preferably has a width that is greater than an average particle size, preferably greater than a maximum particle size.

The particle size or particle size can possibly be determined by laser diffraction methods (in particular by means of laser diffraction measurement according to ISO 13320 or ASTM B822). Alternatively or additionally, the particle sizes can be determined by measuring (for example by means of a microscope) and/or with dynamic image analysis (preferably according to ISO 13322-2, possibly by means of the CAMSIZER® XT of Retsch Technology GmbH). If the particle size is determined from a 2-dimensional image (e.g. of a microscope, in particular an electron microscope), preferably the respective diameter (maximum diameter or equivalent diameter) resulting from the 2-dimensional image is used.

The (average) grain size or particle size of the individual particles of the build-up material is preferably a d50 particle size. In the case of the average particle size, the indication d (numerical value) stands for the number of particles (in mass and/or volume percent) that are smaller than or equal to the indicated grain size or particle size (i.e. for a d50 of 50 μm, 50% of the particles have a size of ≤50 μm). The particle size is preferably determined by the diameter of a single particle, which in turn may possibly be the respective maximum diameter (=supremum of all distances per two points of the particle) or a sieve diameter or an (especially volume-related) equivalent sphere diameter.

The build-up material preferably has a (mean) particle size of at least 50 nm, further preferably at least 200 nm and/or at most 300 μm, optionally at most 80 μm.

The individual particles of the build-up material can (at least approximately) be the same size or there can be a particle size distribution.

If a particle size distribution is present, the gap preferably has a width that is greater than a d50 particle size, in particular greater than a d70 particle size, preferably greater than a d90 particle size, optionally greater than a maximum particle size. Particularly preferably, a width of the gap is at least 1.1 times, further preferably at least 1.5 times, still further preferably at least 2 times and/or at most 100 times, preferably at most 50 times as large as the respective (e.g. average) particle size.

Generally, it is not absolutely necessary that a width of the gap is larger than the particle size of the “largest” particle or grain. A seal can then be achieved, for example, via particles of the build-up material penetrating the gap that are smaller than the largest particle. In particular, if the width is set at least larger than the medium particle size, an advantageous compromise can be achieved between the manufacturing effort in dimensioning the gap (the smaller the width, the more precise it has to be worked) and sealing function.

In particular, it possibly is to be taken into account that a very narrow gap can impede the relative movement between carrier and the building shaft or even make it impossible (due to jamming, for example in the case of unavoidable deformations during operation).

Under a width of the gap it is in particular to be understood a distance between inner wall of the building shaft and carrier. This distance may be constant, but may possibly also vary. In the latter case, a maximum width (that is a maximum distance) should be used as width or, possibly, a medium distance (in the geometric mean).

The gap can have (at least in sections) a width of at least 100 nm, preferably at least 100 μm, possibly at least 1 mm and/or at most 5 mm, possibly at most 2 mm. With such a dimensioning, different build-up materials can be employed and at the same time a sealing function can be realised.

The build-up material can comprise at least one metal and/or at least one ceramic material and/or at least one plastic, in particular at least one polymer.

Preferably, the build-up material is a material having a melting temperature of at least 300° C., preferably at least 500° C., optionally at least 800° C. and/or up to 1000° C., or optionally more.

In one embodiment, the building shaft may be (vertically) movable relative to the carrier in a carrier shaft extending circumferentially relative to the carrier. A distance between an inner wall of the carrier shaft and an outer wall of the carrier is preferably at least one wall thickness of the building shaft, in particular plus at least 200 nm, preferably plus at least 200 μm and/or plus at most 4 mm, preferably at most plus at most 2.5 mm.

A wall thickness of the building shaft is preferably at least 2 mm, further preferably at least 4 mm and/or at most 10 mm, preferably at most 6 mm.

The carrier shaft may be (fixedly) arranged on the carrier, in particular attached thereto. If necessary, the carrier shaft can also be formed integrally, in particular monolithically, with the carrier. A vertical extension of the carrier shaft preferably corresponds to at least 50%, further preferably at least 90% and/or at most 150%, preferably at most 120%, of a vertical extension of the carrier and/or the belly shaft.

At least in an initial state (upon application of the first layer of the build-up material), the building shaft may be accommodated in the carrier shaft over at least 50%, preferably at least 80%, more preferably 95% of its vertical extension. Possibly, a flange of the building shaft rests on the carrier shaft (on the upper side) and/or projects beyond it.

In a specific embodiment, a collection device is provided, in particular around the carrier and/or around the carrier shaft (in particular directly adjoining the latter, on the outside) and/or at least in sections below a section, preferably a flange section, of the building shaft, in order to collect excess material, in particular as soon as the building shaft is raised above a level of the building platform. The collection device thus serves in particular to collect material when the manufacture of the element is finished.

In order to be able to remove the element, the building shaft can preferably be arranged such that material can flow off or run off between a lower end of the building shaft and the building platform or the carrier. This material not used in the building process can then be at least partially collected in the collection device. The collection device thus has in particular the function of collecting material after completion of the manufacturing process. In this way, excess material can be collected in a simple manner and for example be reused.

The collection device (in particular an upper end thereof) can (in at least one state, in particular always) be designed higher than the carrier shaft (in particular as an upper end thereof). By that, it can be achieved in particular that the build-up material at first flows into the collection device.

In a further embodiment, a receiving device is provided to receive material that is conveyed beyond the building shaft, in particular a flange section thereof, upon coating (during coating). The receiving device may be an additional device to the collection device (or separated therefrom). However, the collection device and the receiving device can also be formed (partially or completely) by a common collecting and receiving device.

At least one opening can be provided in the building shaft, in particular a (the) flange section, in particular in order to be able to collect or receive build-up material below the opening. Also by this an easy collection of excess build-up material can be made possible.

This opening is in particular an additional opening or additional aperture, in particular in addition to an (present in an upwardly open building shaft) “opening”, within which the building platform is moved upwards and downwards (seen relatively). The opening in the building shaft, in particular in the flange section, preferably has a cross-sectional area which is at most half as large as a surface area of the building platform.

In one embodiment, the manufacturing device comprises a control device configured to control the build-up process.

The manufacturing device, in particular its control device, is preferably configured to build an additional element around the 3-dimensional element (at least in sections) during the manufacturing of the 3-dimensional element. The additional element preferably has an opening, in particular in a region close to the building platform.

Further preferably, the additional element is (at least) open to the greatest possible extent in the region close to the building platform.

Under a region close to the building platform is in particular to be understood a region which, starting from the building platform, extends to a height relative to a level of the building platform of at least 1%, preferably at least 5%, and/or to a height of at most 20%, preferably at most 10%, of the vertical extent of the additional element. Preferably, the additional element is open to the greatest possible extent in the region close to the building platform, which is intended to mean in particular that at least one horizontal section lying in the region close to the building platform, in particular a section at the level of the surface of the building platform, is defined to at least 50%, preferably 70% and/or at most 99% by corresponding open points.

Through such an additional object, excess build-up material between additional object and object can flow off in a simple manner (after vertical relative movement of the building shaft).

By such an additional object in particular a space from which build-up material can tile-after into the gap from an object build-up region. Build-up material can preferably tile into the gap between the building shaft and the additional object (during an irradiation) without affecting the object build-up region (at least if the additional object region is solidified before the object region).

In specific embodiments, no or at least no sealing element, in particular made of rubber and/or felt, (completely) sealing the building shaft against the carrier is arranged between the building shaft and the carrier. Alternatively or additionally, no or at least no sealing element, in particular made of rubber and/or felt, completely sealing the building shaft against the building platform is arranged between the building shaft and the building platform.

Preferably, no bellows structure is employed under the building platform.

The above-mentioned object is further solved in particular by a manufacturing method for additive manufacturing of 3-dimensional elements by layer-by-layer application by means of at least one coating unit and locally selective solidification of a build-up material by means of at least one irradiation unit, in particular using a manufacturing device of the above type, wherein the element is built up on a building platform arranged on a carrier within a building shaft, wherein the building shaft with respect to the building platform is changed in its height (relatively seen) and is sealed with respect thereto during the layer-by-layer application in that between an inner surface of the building shaft and the carrier and/or the building platform a gap is formed such that a part of the build-up material can at least partially penetrate into the gap to thereby seal the building shaft against the carrier.

Preferably, the gap has a width that is larger than a (mean) particle size, in particular larger than a maximum particle size, of the build-up material.

During the manufacture of the 3-dimensional element, an additional element can be built up around the 3-dimensional element, wherein the additional element preferably has at least one opening, in particular in a region close to the building platform, in particular being open to the greatest possible extent in the region close to the building platform.

The build-up material is preferably heated (at least locally) to at least 300° C., preferably at least 500° C., during manufacture. Insofar as according to the invention the manufacturing device is concerned, it is preferably configured accordingly to enable such a heating.

The above-mentioned object is further solved in particular by a system comprising the manufacturing device of the above kind, in particular configured for carrying out the above manufacturing process, as well as the build-up material.

For example, the building shaft may be at least partially formed of a ceramic material and/or a metal.

The building platform and/or the carrier may, if necessary, be heated (or cooled). Upon a heating, building platform and/or carrier expands/expand. The gap between inner surface of the building shaft and building platform and/or carrier and/or any space (gap) between an inner surface of the carrier shaft and an outer surface of the building shaft is/are then preferably so large that a thermal expansion does not lead to jamming.

Preferably, a respective clearance or the width of the gap is at least 100 nm, preferably at least 100 μm, possibly at least 1 mm, and/or at most 5 mm, in particular at most 2 mm.

With such clearances or gap widths, possibly occurring temperature-related expansions of the building shaft can be tolerated (even if the building shaft is not heated, but continues to heat up due to the build-up material and thus expands). Further embodiments result from the dependent claims.

In the following, the invention is described by means of execution examples which are explained in more detail with reference to the figure.

Hereby show:

FIG. 1 a schematic sectional view of a manufacturing device according to the invention;

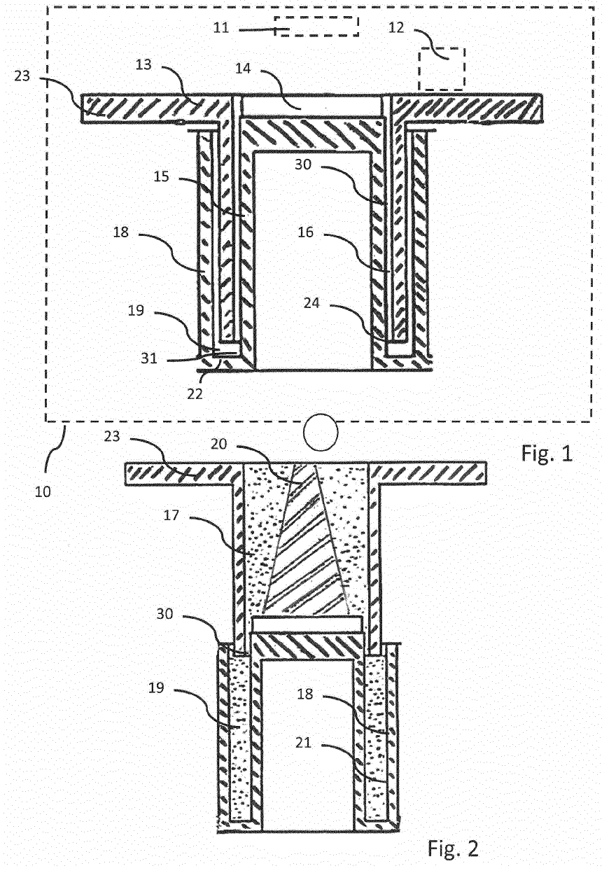

FIG. 2 a detail of the manufacturing device according to FIG. 1 in a state differing from FIG. 1;

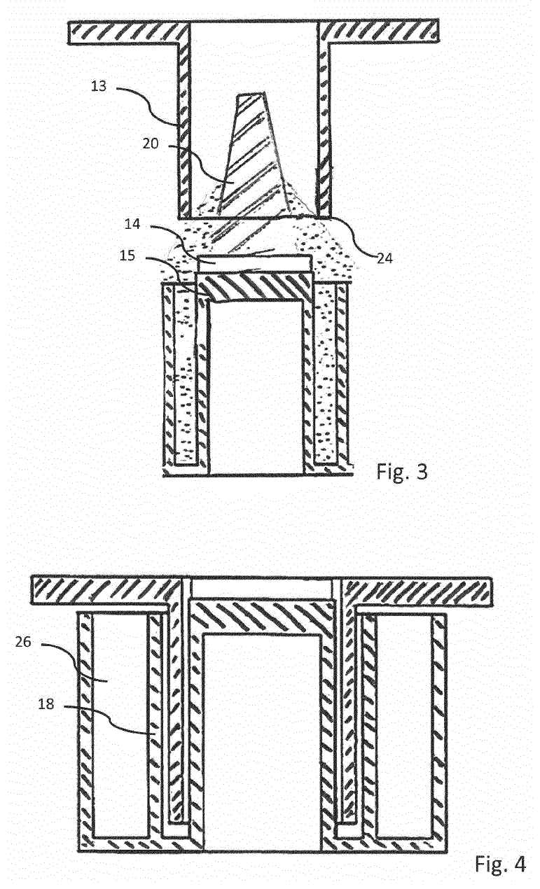

FIG. 3 the detail according to FIG. 2 in a further, differing, state;

FIG. 4 a schematic cross-section of a section of a further embodiment of a manufacturing device according to the invention;

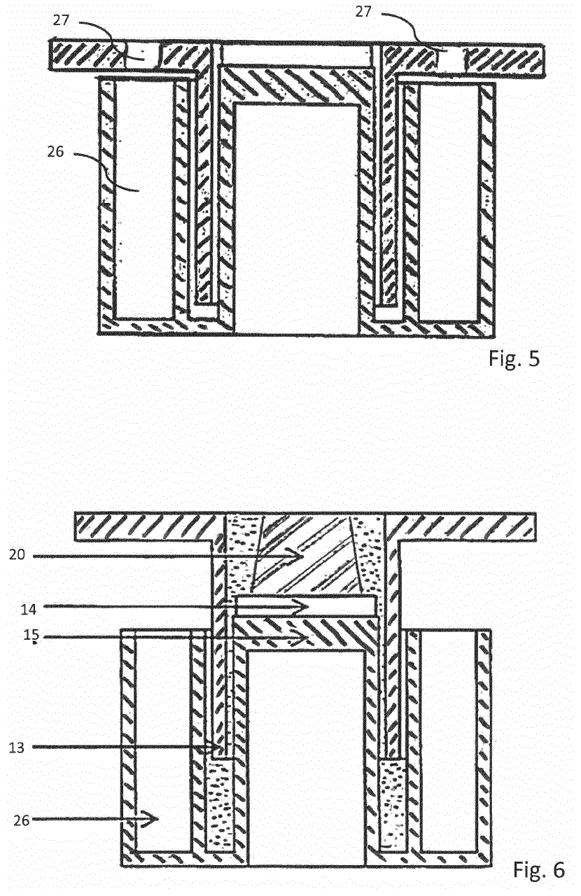

FIG. 5 a detail analogous to FIG. 4 of a further embodiment of the manufacturing device;

FIG. 6 the detail according to FIG. 4 in a differing state;

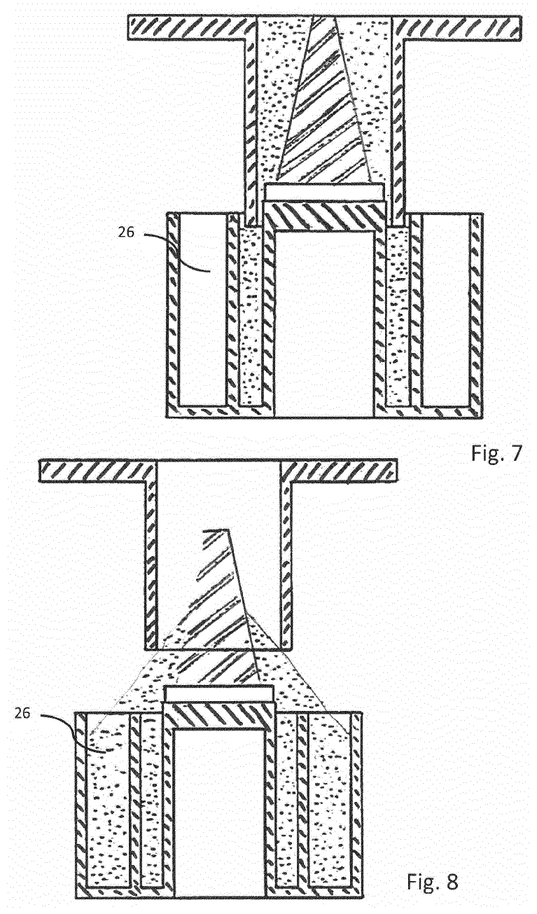

FIG. 7 the detail according to FIG. 4 in a further, differing state;

FIG. 8 the detail according to FIG. 4 in a further, differing state;

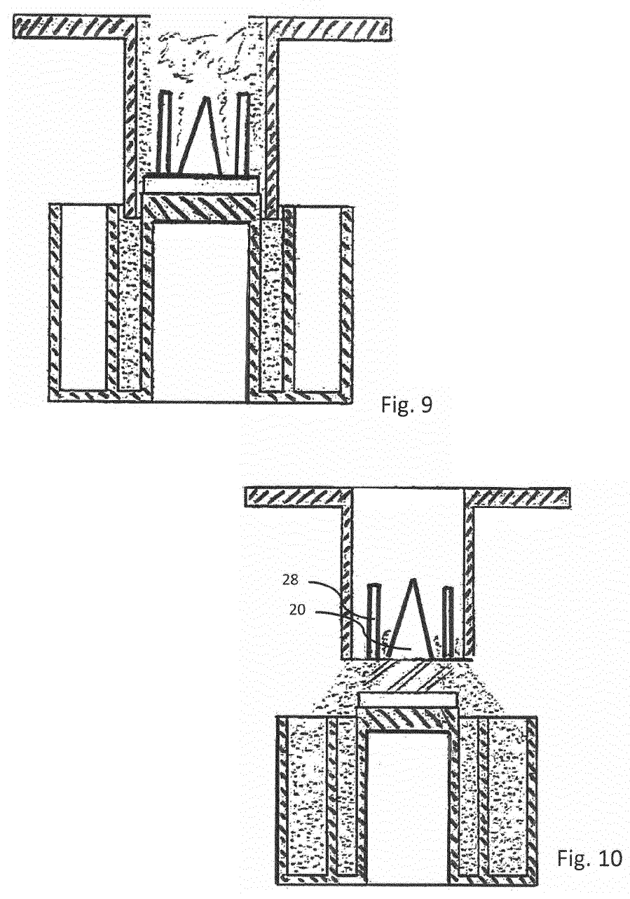

FIG. 9 a detail analogous to FIG. 2 with an additional object;

FIG. 10 the detail according to FIG. 9 in a further, differing state.

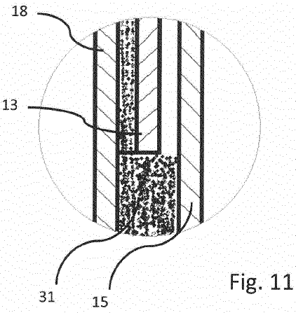

FIG. 11 an enlarged detail of the embodiment according to FIGS. 1 to 3.

In the following description, the same reference numerals are used for same parts and parts having the same effect.

FIG. 1 shows a manufacturing device according to the invention in cross-section (partly purely schematic, which is represented by dashed lines). The manufacturing device comprises a housing 10, an irradiation unit 11 as well as a coating unit 12.

Furthermore, the manufacturing device comprises a building shaft 13, a building platform 14 as well as a carrier 15 for the building platform 14. In the state (initial state of a corresponding manufacturing process) according to FIG. 1, a gap 30 is formed between an inner wall 16 of the building shaft 13 and the carrier 15. Build-up material 17 (shown in FIG. 2) can run into this gap 30 during layer-by-layer application by the coating unit 12.

On the outside opposite the building shaft 13 is a carrier shaft 18, so that altogether (a hollow cylindrical) receiving space 19 is formed between carrier 15 and carrier shaft 18, in which the building shaft 13 can be moved in relation to the carrier 15.

Specifically, the carrier 15 can be lowered relative to the building shaft 13 for this purpose (or vice versa, the building shaft 13 can be raised, or both).

In FIG. 2, a state is shown in which the manufacturing device is when the manufacturing process is finished or at least almost finished. Here, the 3-dimensional object 20 as well as non-consumed build-up material 17 can also be seen. The material flowing into the gap 30 (which becomes successively shorter in the vertical direction) during the transition between the states according to FIGS. 1 and 2 fills here almost the entire receiving space 19 between the carrier 15 and an inner wall 21 of the carrier shaft 18.

In a concrete embodiment, the carrier shaft 18 forms a one-piece (possibly monolithic) body with the carrier 15 (as well as a horizontal transition section 22 or bottom of the receiving space 19). However, the carrier shaft 18 (possibly including transition section 22 or without transition section 22) can also be arranged as a separate element (element) (but is preferably firmly connected to the carrier 15).

Before the start of a manufacturing process (that is in the state according to FIG. 1), the gap 30 can possibly be completely filled with build-up material (by “overdosing”). A section 31 (pocket) between the lower end of the gap 30 and bottom 22 can also be filled with build-up material. This can then result in self-inhibition due to gravity. This section 31 (pocket) is comparatively small (in vertical direction) in the initial state, so that only little build-up material is needed to fill it. In the ongoing manufacturing process, the carrier is lowered and further build-up material flows (loosely) through the inner gap 30 into section 31 (the pocket), whereby this is filling further. This is illustrated again in the detail according to FIG. 11.

The building shaft 13 has a flange section 23 which projects above the carrier shaft 18 and during the manufacturing process is preferably flush with the uppermost, most recently applied layer in each case.

FIG. 3 shows the detail according to FIG. 2 in a further state, namely after completion of the object 20. In this state, the building shaft 13 is moved relative to the carrier 15 or the building platform 14 to such an extent that excess build-up material 17 can flow off (run off) between a lower edge 24 of the building shaft 13 as well as the building platform 14. The material possibly then can further (possibly completely) fill the receiving space 19, but can also, if necessary, (additionally) flow beyond the receiving space 19 (and be received, for example, by a further receiving and/or collection device, as shown in further execution examples).

By means of the gap 30 and the section 31 (pocket), a seal is achieved in a simple manner, as material (see in particular FIG. 1) is prevented from further flowing away due to friction inherent in the build-up material and possibly also due to a gravity from material located on the outside of the building shaft 13. The build-up material thus inhibits itself.

The build-up material 17 can in each case (see FIGS. 1 and 2) fill a section between inner wall 16 of the building shaft 13 and the carrier 15, and on the other hand a section below a lower edge 24 of the building shaft 13. In addition, if necessary, there can be at least a small section on the outside of the building shaft 13, due to a force resulting from a corresponding build-up material column in the area of the gap 30. FIG. 4 shows a further embodiment of the manufacturing device according to the invention. This corresponds in principle to the embodiment according to FIGS. 1 to 3, wherein additionally a collection device 26 is provided which is arranged around the carrier shaft 18.

The collection device 26 can be arranged around the carrier shaft 18 and, if necessary, be integrally formed (in particular monolithically) on the latter (or with the latter). It is also conceivable that the collection device 26 is designed as a separate element (element) (but preferably firmly connected to the carrier shaft 13 or at least movable simultaneously therewith). In particular, if the carrier 15 is not lowered, but the building shaft is raised during manufacturing, the collection device 26 can also be formed by a separate (possibly also not firmly connected) element.

FIG. 5 shows a further embodiment of the manufacturing device according to the invention with one difference compared to the embodiment according to FIG. 4, namely at least one opening 27 for excess build-up material. Through the respective opening 27, excess build-up material (by the coater after passing over the building plane) can flow off into the collection device 26.

Alternatively or additionally, it may be a function of the opening 27 to create a connection so that no (relative) gas pressure can build up that pushes build-up material up into the space between inner wall of the carrier shaft 18 and outer wall of the building shaft 13.

FIG. 6 again shows the embodiment according to FIG. 4, whereby the building shaft has been moved (approximately) half the distance compared to the position according to FIG. 7 relative to the carrier.

FIG. 7 shows a position analogous to FIG. 2 for the embodiment according to FIG. 4.

FIG. 8 shows a position analogous to FIG. 3 for the embodiment according to FIG. 4.

In FIG. 8 it can be seen that excess build-up material can also be collected, in particular by the collection device 26 (after removing the building shaft from the carrier).

FIG. 9 shows again basically the embodiment according to FIG. 4 (in a position analogous to FIG. 7), whereby here, in addition to the object 20, an additional object 28 has been built around the object. FIG. 9 then shows a flow off of the (unsolidified) build-up material below the additional object 28 or in openings in a lower area of the additional object 28.

For example, a vertical adjustment between building shaft and carrier can be carried out by means of spindle rods (which are driven in rotation). These can, for example, raise the building shaft, whereby the carrier preferably remains at a constant height. Alternatively or additionally, the carrier can be (actively) lowered.

At this point, it should be noted that all the parts described above, taken on their own and in any combination, in particular the details shown in the drawings, are claimed as embodiments of the invention. Modifications thereof are familiar to the person skilled in the art.

### LIST OF REFERENCE SIGNS

10 housing
11 irradiation unit
12 coating unit
13 building shaft
14 building platform
15 carrier
16 inner wall
17 build-up material
18 carrier shaft
19 receiving space
20 object
21 inner wall
22 transition section (bottom)
23 flange section
24 lower edge
26 collection device
27 opening
28 additional object
30 gap
31 section (pocket)

1. Manufacturing device for additive manufacturing of three-dimensional elements by layer-by-layer application by means of at least one coating unit and locally selective solidification of a build-up material by means of at least one irradiation unit, comprising a building shaft and a carrier as well as a building platform, wherein the element can be built up on the building platform within the building shaft, wherein the building shaft can be changed relatively in height with respect to the building platform and is sealable with respect to the latter and/or the carrier during the layer-by-layer application, in that during the layer-by-layer application between an inner surface of the building shaft and the carrier and/or between an inner surface of the building shaft and the building platform a gap is formed such that a part of the build-up material can at least partially penetrate in order to thereby seal the building shaft with respect to the building platform and/or the carrier.

2. Manufacturing device according to claim 1,
characterized in that
for sealing purposes, at least in one state, during the layer-by-layer application below the gap and/or below a lower end of the building shaft, a section is formed, which successively increases in size and fills with build-up material.

3. Manufacturing device according to claim 1,
characterised in that
the building shaft is sealable with respect to the building platform and/or the carrier by means of self-sealing.

4. Manufacturing device according to claim 1,
characterized in that
the manufacturing device comprises the build-up material, wherein the gap has, at least in sections, a width which is greater than an average particle size.

5. Manufacturing device according to claim 1,
characterised in that
the gap has, at least in sections, a width of at least 100 nm.

6. Manufacturing device according to claim 1,
characterized in that
the building shaft is movable relative to the carrier in a carrier shaft extending circumferentially relative to the carrier, wherein a distance between an inner wall of the carrier shaft and an outer wall of the carrier is at least one wall thickness of the building shaft, and/or plus at most 4 mm.

7. Manufacturing device according to claim 1,
characterized in that
a collection device is provided around the carrier and/or around the carrier shaft and/or at least in sections below a section of the building shaft, in order to collect excess material as soon as the building shaft is arranged above a level of the building platform.

8. Manufacturing device according to claim 1,
characterized in that
a receiving device is provided for receiving material which is conveyed out of the building shaft during coating.

9. Manufacturing device according to claim 1,
characterized in that at least one opening is provided in the building shaft in order to be able to collect or receive excess build-up material below the opening.

10. Manufacturing device according to claim 1,
characterized in that
the manufacturing device is configured to build up an additional element around the three-dimensional element during the manufacture of the three-dimensional element, wherein the additional element has at least one opening.

11. Manufacturing method for the additive manufacturing of three-dimensional elements by layer-by-layer application by means of at least one coating unit and locally selective solidification of a build-up material by means of at least one irradiation unit, wherein the element is built up on a building platform arranged on a carrier within a building shaft, wherein the building shaft with respect to the building platform is changed in a height and is sealed with respect thereto and/or with respect to the carrier during the layer-by-layer application, in that between an inner surface of the building shaft and the carrier and/or the inner surface of the building shaft and the building platform a gap is formed such that a part of the build-up material can at least partially penetrate to thereby seal the building shaft against the building platform and/or the carrier.

12. Manufacturing method according to claim 11,
characterized in that
the gap has a width which is greater than an average particle size.

13. Manufacturing method according to claim 11,
characterised in that
during the manufacture of the three-dimensional element, an additional element is built up around the three-dimensional element, wherein the additional element has at least one opening.

14. Manufacturing method according to claim 11,
characterized in that
the build-up material is heated locally to at least 300° C.

15. System comprising the manufacturing device according to claim 1, as well as the build-up material.

16. System according to claim 15,
characterized in that
a mean particle size of the build-up material is at least 50 nm and/or at most 300 μm.
